(19) United States
(12) Patent Application Publication
(10) Pub. No.: US 2025/0114182 A1
(43) Pub. Date: Apr. 10, 2025

(54) ANIMAL CARE CHAMBER

(71) Applicant: AUTOELEX CO., LTD., Gimhae-si, Gyeongsangnam-do (KR)

(72) Inventor: Jongyoon BAE, Busan (KR)

(21) Appl. No.: 18/836,357

(22) PCT Filed: Nov. 8, 2022
(86) PCT No.: PCT/KR2022/017391

§ 371 Date: Aug. 7, 2024

(30) Foreign Application Priority Data
Feb. 15, 2022 (KR) 10-2022-0019628

(51) Int. Cl. A61D 7/04; A61G 10/02

(52) U.S. Cl. CPC A61D 7/04; A61G 10/02

(57) ABSTRACT

The present invention is directed to an animal care chamber. The animal care chamber includes: a case provided with a door that can be selectively opened and closed, and configured to provide a space; a control unit configured to control the operation of an oxygen sensor, an oxygen pump, an oxygen valve, or a temperature adjustment unit; the oxygen pump configured to discharge air into the case while sucking in the air inside the case; the oxygen sensor connected to the oxygen pump, and configured to measure the oxygen concentration of air; the oxygen valve connected to the inside of the case and an oxygen generator to allow oxygen to selectively flow into the case or out of the case; the temperature adjustment unit configured to control the internal temperature of the case; and a cover configured to block a plurality of components from being exposed to the outside.

### TECHNICAL FIELD

The present invention relates to an animal care chamber, and more particularly, to an animal care chamber that allows temperature and oxygen concentration control to be performed constantly for the care of an animal.

### BACKGROUND ART

A phenomenon occurs in which as society develops, it becomes materially rich, but becomes emotionally deprived.

Accordingly, people often welcome companion animals as new family members for emotional stability.

As companion animals are living creatures, living with them requires lots of sincerity and financial costs.

In this case, what comes first is the health issue of companion animals.

However, general companion animal owners who are not experts on companion animals do not know in detail about the health status of their companion animals.

Furthermore, it is sufficient to visit a veterinary hospital when a companion animal is seriously ill, but it is difficult to visit a veterinary hospital every time a companion animal shows a mild symptom.

Accordingly, there is a need for a chamber that provides care for a companion animal when the health status of the companion animal is suspected so that the health status of the companion animal can improve or be prevented from further deteriorating.

In connection with this, Korean Patent No. 10-2354642 discloses a healthcare house system for a companion animal that checks the health status of a companion animal and matches a related respondable organization with an abnormality when there is the abnormality in the health status of the companion animal, and also discloses a healthcare method using the healthcare house system.

However, the healthcare house system for a companion animal and the healthcare method using the same according to the prior art have a problem in that excessive costs are incurred due to the addition of unnecessary functions.

Additionally, although there is provided a temperature sensor configured to measure changes in the body temperature of a companion animal, there is a problem in that the temperature inside the cover cannot be controlled.

### DISCLOSURE

### Technical Problem

Accordingly, the present invention has been conceived to overcome the problems of the prior art described above, and an object of the present invention is to provide an animal care chamber that allows temperature and oxygen concentration control to be performed constantly for the care of an animal.

### Technical Solution

According to the features of the present invention for achieving the above-described object, there is provided an animal care chamber, including: a case provided with a door that can be selectively opened and closed, and configured to provide a space in which a companion animal can stay; a control unit provided on one side of the case, and configured to control the operation of an oxygen sensor, an oxygen pump, an oxygen valve, or a temperature adjustment unit; the oxygen pump provided on one side of the case, and configured to discharge air into the case while sucking in the air inside the case; the oxygen sensor connected to the oxygen pump, and configured to measure the oxygen concentration of the air sucked in by the oxygen pump; the oxygen valve provided on one side of the case, and connected to the inside of the case and an oxygen generator to allow the oxygen, generated from the oxygen generator, to selectively flow into the case or flow out of the case; the temperature adjustment unit provided on one side of the case, and configured to control the internal temperature of the case; and a cover provided on one side of the case, and configured to block a plurality of components from being exposed to the outside.

The oxygen valve may include: a valve body forming the external shape; a power unit provided on one side of the valve body, and configured to provide power for the rotation of a cam disk; a first pipe connected to the valve body, and connected to the oxygen generator to allow oxygen to flow into the valve body; a second pipe connected to the valve body, and configured to allow the oxygen, introduced into the valve body, to flow into the case; a third pipe connected to the valve body, and configured to allow the oxygen, introduced into the valve body, to flow out of the cover; and the cam disk provided inside the valve body, and configured to allow the oxygen, flowing from the first pipe into the valve body, to be selectively supplied to any one of the second and third pipes.

A silencer connected to the second pipe so that the noise generated in the process of supplying oxygen to the inside of the case can be reduced may be provided on one side of the case.

The temperature adjustment unit may include: a heater provided on one side of the case, and configured to selectively radiate heat; and a fan provided on one side of the heater, and configured to allow the heat, generated from the heater, to be supplied to the inside of the case.

A plurality of circulation holes configured such that the air heated by the temperature adjustment unit can be circulated through the inside of the case may be formed on one side of the case, a partition configured to allow the temperature adjustment unit to be partitioned from other components when combined with the cover may be formed to protrude from one side of the case, and a coupling portion configured to allow the temperature adjustment unit to be partitioned from other components provided between the case and the cover when combined with the case along with the partition may be formed to protrude from one side of the cover.

### ADVANTAGEOUS EFFECTS

The animal care chamber according to the present invention has the following advantages:

The present invention has the advantage of maintaining the internal temperature of the case at a set temperature by providing the temperature adjustment unit, thereby providing heating to a companion animal staying inside the case.

The present invention has the advantage of providing the oxygen sensor, the oxygen pump, and the oxygen valve, thereby keeping the oxygen concentration of the air inside the case constant.

The present invention has the advantage of providing the silencer, thereby significantly reducing the noise generated in the process of supplying oxygen from the oxygen valve into the case.

### DESCRIPTION OF DRAWINGS

FIG. 1 shows a perspective view showing the configuration of a preferred embodiment of an animal care chamber according to the present invention;

FIG. 2 shows a right sectional view showing the configuration of the preferred embodiment of the animal care chamber according to the present invention;

FIG. 3 shows a front sectional view showing the configuration of the preferred embodiment of the animal care chamber according to the present invention;

FIG. 4 shows a plan sectional view showing the configuration of the preferred embodiment of the animal care chamber according to the present invention;

FIG. 5 shows a perspective view showing the configuration of an oxygen valve constituting part of the preferred embodiment of the animal care chamber according to the present invention; and

FIG. 6 shows a sectional view showing the configuration of the oxygen valve constituting part of the preferred embodiment of the animal care chamber according to the present invention.

### MODE FOR INVENTION

Hereinafter, preferred embodiments of an animal care chamber according to the present invention will be described with reference to the drawings.

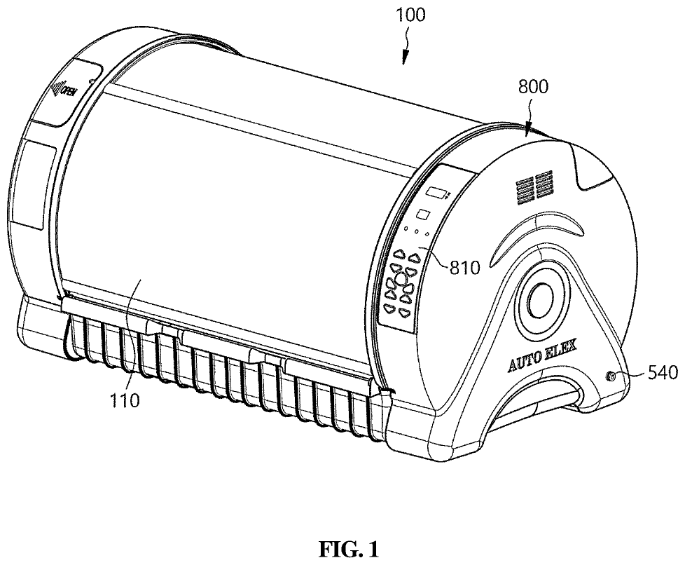

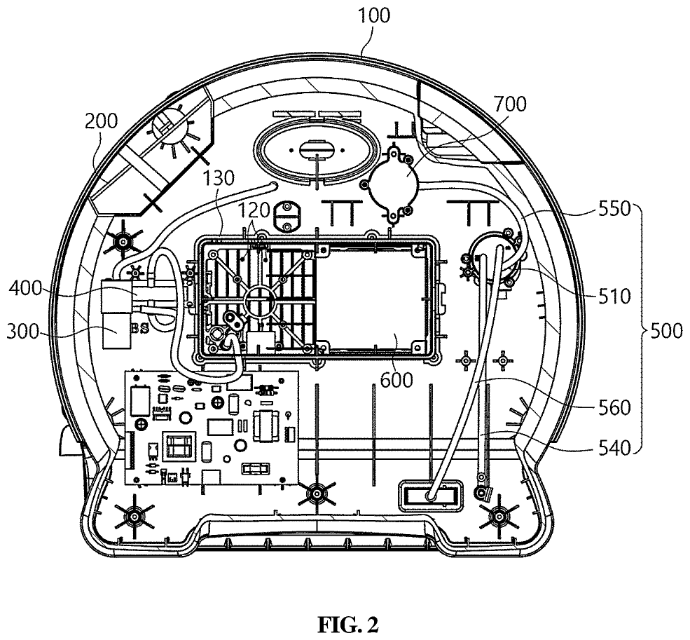

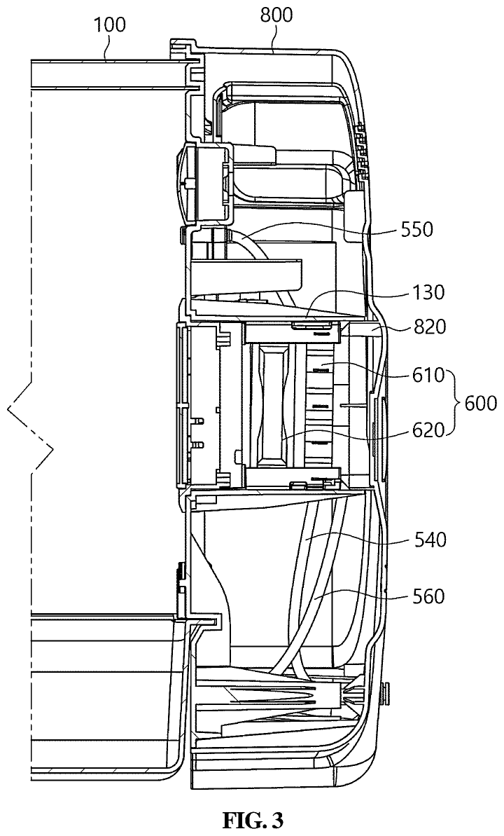

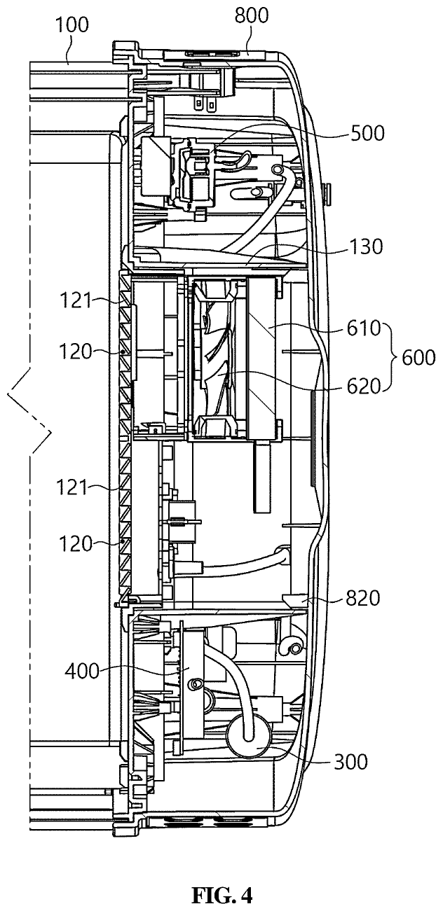

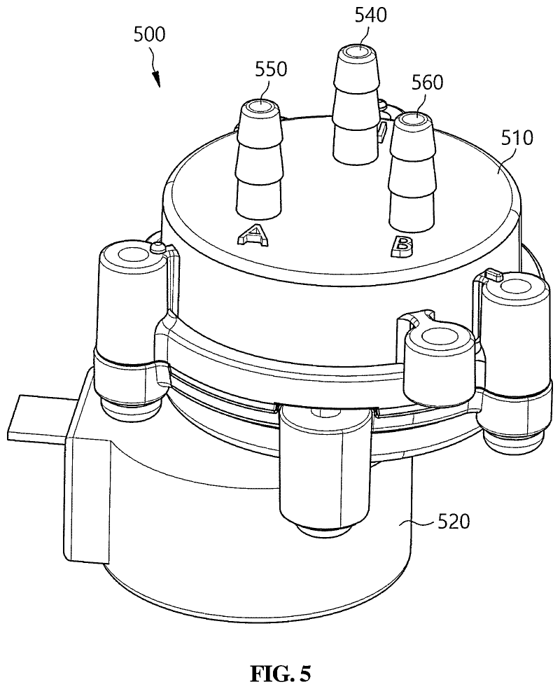

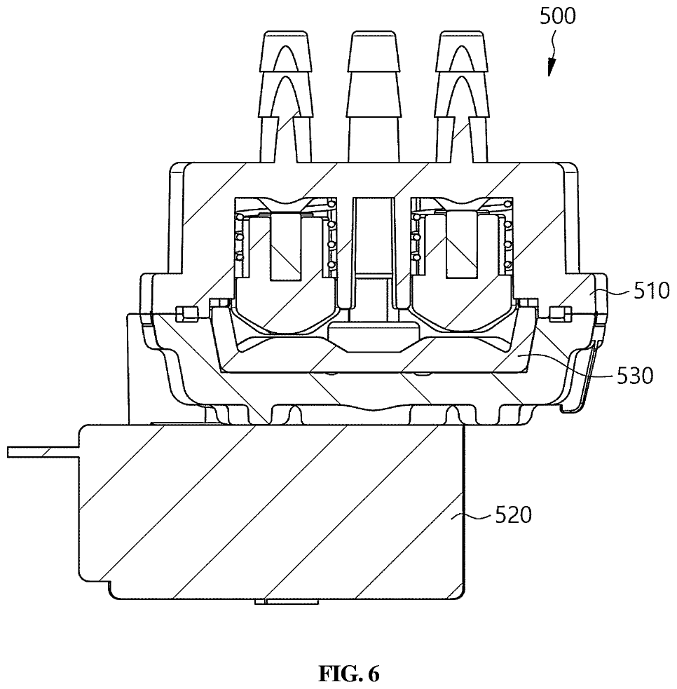

As shown in the drawings, an embodiment of an animal care chamber according to the present invention is shown in FIGS. 1 to 6. That is, FIG. 1 shows a perspective view showing the configuration of a preferred embodiment of the animal care chamber according to the present invention, FIG. 2 shows a right sectional view showing the configuration of the preferred embodiment of the animal care chamber according to the present invention, FIG. 3 shows a front sectional view showing the configuration of the preferred embodiment of the animal care chamber according to the present invention, FIG. 4 shows a plan sectional view showing the configuration of the preferred embodiment of the animal care chamber according to the present invention, FIG. 5 shows a perspective view showing the configuration of an oxygen valve constituting part of the preferred embodiment of the animal care chamber according to the present invention, and FIG. 6 shows a sectional view showing the configuration of the oxygen valve constituting part of the preferred embodiment of the animal care chamber according to the present invention.

As shown in these drawings, the animal care chamber according to the present invention includes: a case 100 provided with a door 110 that can be selectively opened and closed, and configured to provide a space in which a companion animal can stay; a control unit 200 provided on one side of the case 100, and configured to control the operation of an oxygen sensor 400, an oxygen pump 300, an oxygen valve 500, or a temperature adjustment unit 600; the oxygen pump 300 provided on one side of the case 100, and configured to discharge air into the case 100 while sucking in air inside the case 100; the oxygen sensor 400 connected to the oxygen pump 300, and configured to measure the oxygen concentration of the air sucked in by the oxygen pump 300; the oxygen valve 500 provided on one side of the case 100, and connected to the inside of the case 100 and an oxygen generator to allow the oxygen generated from the oxygen generator to selectively flow into the case 100 or flow out of the case 100; the temperature adjustment unit 600 provided on one side of the case 100, and configured to control the internal temperature of the case 100; and a cover 800 provided on one side of the case 100, and configured to block a plurality of components from being exposed to the outside.

The case 100 is formed in a shape similar to a hollow hemisphere, and is a part in which a door 110 is formed such that a companion animal can enter and exit the inside through the door 110.

In this case, the door 110 may be provided to slide along the inside or outside of the case 100, or may be partially provided in a form that can be opened and closed.

Additionally, a plurality of circulation holes 120 configured such that the air heated by the temperature adjustment unit 600 can be circulated through the inside of the case 100 are formed on one side of the case 100.

The circulation holes 120 are formed on the right side of the case 100 (in FIG. 3), and allow the air inside the case 100 to circulate through the temperature adjustment unit 600.

That is, the circulation holes 120 are configured to allow heated air to flow into the inside of the case 100 through the temperature adjustment unit 600, or are configured to allow the air inside the case 100 to flow into the temperature adjustment unit 600.

It would be preferable to form the plurality of circulation holes 120 rather than a single circulation hole for the safety of a companion animal that stays inside the case 100.

The reason for this is that the companion animal may be injured by a fan 620 that forms part of the temperature adjustment unit 600.

Additionally, guide blades 121 are further provided inside the circulation holes 120.

The guide blades 121 are provided inside the circulation holes 120. The guide blades 121 are configured to indirectly provide warmth inside the case 100 through the side so that the warm air flowing in from the temperature adjustment unit 600 through the circulation holes 120 does not come into directly contact with a companion animal, or are configured to prevent the hair and/or the like of a companion animal from being sucked in by allowing the air, flowing from the circulation holes 120 into the temperature adjustment unit 600, to flow in even inside the case 100 from the side.

To this end, the guide blades 121 may be preferably disposed inclined upward or downward with respect to the center of the plurality of circulation holes 120.

That is, the guide blades 121 are disposed at an angle such that the air discharged through the temperature adjustment unit 600 can be discharged at an angle from the right end to the left in the range from the center of the plurality of circulation holes 120 to the top (in FIG. 4). The guide blades 121 are disposed at an angle such that the air flowing into the temperature adjustment unit 600 from the inside of the case 100 can be entered at an angle from the right end to the left in the range from the center of the plurality of circulation holes 120 to the bottom (in FIG. 4).

As the guide blades 121 are arranged in different directions based on the center of the plurality of circulation holes 120 in this manner, the air inside the case 100 is circulated along the circumference of the case 100 (in FIG. 4).

Additionally, a partition 130 configured to allow the temperature adjustment unit 600 to be partitioned from other components when combined with the cover 800 is formed to protrude from one side of the case 100.

The partition 130 is formed to protrude to the right from the right surface of the case 100 (in FIG. 3), and has a shape similar to a square pillar.

That is, the partition 130 has a shape similar to a square pillar that protrudes from the outer periphery of the plurality of circulation holes 120.

By this partition 130, the temperature adjustment unit 600 is partitioned from other components provided on the side surface of the case 100.

Meanwhile, the control unit 200 is provided on the right side surface of the case 100 (in FIG. 3).

The control unit 200 corresponds to a main PCB, and is configured to control the operation of the oxygen pump 300, the oxygen sensor 400, the oxygen valve 500, or the temperature adjustment unit 600.

Additionally, a power supply device configured to supply power to the oxygen pump 300, the oxygen sensor 400, the oxygen valve 500, or the temperature adjustment unit 600 is further provided.

Furthermore, the oxygen pump 300 is provided on the right side surface of the case 100 (in FIG. 3).

The oxygen pump 300 is provided on the right side surface of the case 100, and allows sucked air to be discharged into the case 100 while sucking in the air inside the case 100.

This oxygen pump 300 is configured to be connected to the inside of the case 100 through a tube.

Furthermore, the oxygen sensor 400 is provided on the right side surface of the case 100 (in FIG. 3).

The oxygen sensor 400 is a part that measures the oxygen concentration of the air sucked in from the oxygen pump 300 (the air inside the case).

In this manner, the oxygen concentration in the air inside the case 100 may be measured through the oxygen pump 300 and the oxygen sensor 400, through which it is determined whether to open or close the oxygen valve 500.

Additionally, the oxygen valve 500 is provided on the right side surface of the case 100 (in FIG. 3).

The oxygen valve 500 includes: a valve body 510 forming an external shape; a power unit 520 provided on one side of the valve body 510, and configured to provide power for the rotation of a cam disk 530; a first pipe 540 connected to the valve body 510, and connected to the oxygen generator to allow oxygen to flow into the valve body 510; a second pipe 550 connected to the valve body 510, and configured to allow oxygen, introduced into the valve body 510, to flow into the case 100; a third pipe 560 connected to the valve body 510, and configured to allow the oxygen, introduced into the valve body 510, to flow out of the cover 800; and the cam disk 530 provided inside the valve body 510, and configured to allow the oxygen, flowing from the first pipe 540 into the valve body 510, to be selectively supplied to any one of the second and third pipes 550 and 560.

The valve body 510 is a part that forms the external shape of the oxygen valve 500.

The first pipe 540 is connected to the valve body 510.

The first pipe 540 is a part that is connected to the valve body 510 and the cover 800, and is a part that is connected to the oxygen generator (not shown) through the outside of the cover 800 to allow oxygen to be supplied into the valve body 510.

In this case, the oxygen generator corresponds to a device that continuously supplies oxygen.

Additionally, the second pipe 550 is connected to the valve body 510.

The second pipe 550 is a part that is connected to the valve body 510 and the case 100, and is a part that allows the oxygen, supplied from the first pipe 540 into the valve body 510, to be supplied into the case 100.

Additionally, the third pipe 560 is connected to the valve body 510.

The third pipe 560 is a part that is connected to the valve body 510 and the cover 800, and is a part that allows the oxygen, supplied from the first pipe 540 into the valve body 510, to be discharged out of the cover 800.

In the present invention, the air discharged through the third pipe 560 is discharged through the gap between the case 100 and the cover 800.

Furthermore, the cam disk 530 configured to allow oxygen to be supplied to any one of the second and third pipes 550 and 560 is provided inside the valve body 510.

The cam disk 530 has a shape similar to a circular plate, and is a part that is selectively rotated inside the valve body 510 to impose a limitation so that the oxygen, supplied into the valve body 510 by the first pipe 540, is supplied to any one of the second and third pipes 550 and 560.

Additionally, the power unit 520 is provided on the bottom of the valve body 510.

The power unit 520 is provided on the bottom surface of the valve body 510, and is a part that provides power to selectively rotate the cam disk 530.

For example, the power unit 520 is formed of a geared motor.

In this manner, the selective rotation of the cam disk 530 is made possible by the power unit 520 and the control unit 200.

In other words, when the oxygen concentration of the air inside the case 100 exceeds the oxygen concentration set through the control unit 200, oxygen may be supplied through the third pipe 560 by the rotation of the cam disk 530, thereby preventing further oxygen from being supplied to the inside of the case 100. In contrast, when the oxygen concentration of the air inside the case 100 is lower than the oxygen concentration set through the control unit 200, oxygen may be supplied through the second pipe 550 by the rotation of the cam disk 530, so that oxygen can be supplied into the inside of the case 100.

Furthermore, a silencer 700 connected to the second pipe 550 so that the noise generated in the process of supplying oxygen to the inside of the case 100 can be reduced is provided on one side of the case 100.

The silencer 700 is provided on the right side surface of the case 100 (in FIG. 3), and is a part that reduces the noise of the oxygen supplied from the second pipe 550 into the inside of the case 100.

That is, the oxygen supplied from the second pipe 550 into the case 100 passes through the silencer 700. In this process, the noise generated during the oxygen supply process is significantly reduced.

The oxygen concentration of the air inside the case 100 may be kept constant by the oxygen valve 500 configured in this manner.

Meanwhile, the temperature adjustment unit 600 is provided on the right side surface of the case 100 (in FIG. 3).

The temperature adjustment unit 600 includes: a heater 610 provided on one side of the case 100, and configured to selectively radiate heat; and the fan 620 provided on one side of the heater 610, and configured to allow the heat, generated from the heater, to be supplied to the inside of the case 100.

The heater 610 is provided on the right side surface of the case 100 to be spaced apart from the case 100, and is a part that selectively radiates heat.

For example, the heater 610 is formed of a PTC heater so that radiated temperature can be maintained at a set temperature.

Additionally, the fan 620 is provided between the heater 610 and the right side surface of the case 100.

The fan 620 is a part that allows the heat, radiated from the heater 610, to efficiently flow into the case 100.

The temperature adjustment unit 600 configured in this manner allows the air inside the case 100 to maintain the set temperature.

It is obvious that in the present invention, a configuration is made such that only the heating of the case 100 may be performed for the care of a companion animal, but a configuration may be made such that both cooling and heating may be performed.

Additionally, the temperature adjustment unit 600 may be preferably located inside the partition 130 to prevent other components from being damaged by heat.

Furthermore, in the present invention, a configuration is made such that the temperature adjustment unit 600 is provided only on the right side surface (in FIG. 3) of the case 100. However, in order to reduce the difference in the internal temperature of the case 100, a temperature adjustment unit 600 may be additionally provided on the left side surface of the case 100 (in FIG. 1).

It is obvious that when the temperature adjustment unit 600 is additionally provided on the left side surface of the case 100, the circulation holes 120 for the circulation of the air inside the case 100 and the cover 800 will also need to be additionally formed or provided.

Meanwhile, the cover 800 is provided on the right side surface of the case 100 (in FIG. 3).

The cover 800 is a part that is coupled to the case 100 on the right side surface of the case 100, and is configured to prevent a plurality of components, provided on the right side surface of the case 100, from being exposed to the outside.

Additionally, a coupling portion 820 configured to allow the temperature adjustment unit 600 to be partitioned from other components provided between the case 100 and the cover 800 when combined with the case 100 along with the partition 130 is formed to protrude from one side of the cover 800.

The coupling portion 820 is formed to protrude to the left from the left side surface of the cover 800 (in FIG. 3), and has a shape similar to a square pillar.

This coupling portion 820 is configured to completely block the inside and outside of the partition 130 from each other by coming into contact with the partition 130 when the cover 800 is combined with the case 100.

Additionally, the cover 800 is provided with an operation unit 810, through which the operation of the control unit 200, the internal oxygen concentration of the case 100, or the internal temperature of the case 100 are displayed.

That is, the animal care chamber according to the present invention is provided with the temperature adjustment unit, so that the internal temperature of the case can be maintained at a set temperature, thereby providing heating to a companion animal staying inside the case.

Additionally, the animal care chamber according to the present invention is provided with the oxygen sensor, the oxygen pump, and the oxygen valve, so that the oxygen concentration of the air inside the case can be kept constant.

Furthermore, the animal care chamber according to the present invention is provided with the silencer, so that the noise generated in the process of supplying oxygen from the oxygen valve into the case is significantly reduced.

The scope of the present invention is not limited to the embodiments illustrated above, and many other modifications based on the present invention may be possible to those having ordinary skill in the art within the above-described technical scope.

1. An animal care chamber, comprising:
a case provided with a door that can be selectively opened and closed, and configured to provide a space in which a companion animal can stay;
a control unit provided on one side of the case, and configured to control operation of an oxygen sensor, an oxygen pump, an oxygen valve, or a temperature adjustment unit;
the oxygen pump provided on one side of the case, and configured to discharge air into the case while sucking in air inside the case;
the oxygen sensor connected to the oxygen pump, and configured to measure an oxygen concentration of the air sucked in by the oxygen pump;
the oxygen valve provided on one side of the case, and connected to an inside of the case and an oxygen generator to allow oxygen, generated from the oxygen generator, to selectively flow into the case or flow out of the case;
the temperature adjustment unit provided on one side of the case, and configured to control an internal temperature of the case; and
a cover provided on one side of the case, and configured to block a plurality of components from being exposed to an outside.

2. The animal care chamber of claim 1, wherein the oxygen valve comprises:
a valve body forming an external shape;
a power unit provided on one side of the valve body, and configured to provide power for rotation of a cam disk;
a first pipe connected to the valve body, and connected to the oxygen generator to allow oxygen to flow into the valve body;
a second pipe connected to the valve body, and configured to allow oxygen, introduced into the valve body, to flow into the case;
a third pipe connected to the valve body, and configured to allow oxygen, introduced into the valve body, to flow out of the cover; and
the cam disk provided inside the valve body, and configured to allow oxygen, flowing from the first pipe into the valve body, to be selectively supplied to any one of the second and third pipes.

3. The animal care chamber of claim 1, wherein a silencer connected to the second pipe so that noise generated in a process of supplying oxygen to the inside of the case can be reduced is provided on one side of the case.

4. The animal care chamber of claim 1, wherein the temperature adjustment unit comprises:
a heater provided on one side of the case, and configured to selectively radiate heat; and
a fan provided on one side of the heater, and configured to allow heat, generated from the heater, to be supplied to the inside of the case.

5. The animal care chamber of claim 1, wherein:
a plurality of circulation holes configured such that air heated by the temperature adjustment unit can be circulated through the inside of the case are formed on one side of the case;
a partition configured to allow the temperature adjustment unit to be partitioned from other components when combined with the cover is formed to protrude from one side of the case; and
a coupling portion configured to allow the temperature adjustment unit to be partitioned from other components provided between the case and the cover when combined with the case along with the partition is formed to protrude from one side of the cover.
